(19) United States
(12) Patent Application Publication
(10) Pub. No.: US 2007/0281119 A1
(43) Pub. Date: Dec. 6, 2007

(54) Roofing underlayment

(75) Inventors: Michael Di Stefano, Sparta, NJ (US); Gregg Malanga, Wayne, NJ (US)

Correspondence Address: GAF MATERIALS CORPORATION;Attn: William J. Davis, Esq., Legal Department, Building No. 8-2, 1361 Alps Road, Wayne, NJ, 07470, US

(73) Assignee: BUILDING MATERIALS INVESTMENT CORPORATION

(21) Appl. No.: 11/443,961

(22) Filed: May 31, 2006

(51) Int. Cl. B32B 33/00

(52) U.S. Cl. 428/40.1; 428/195.1

(57) ABSTRACT

A non-skid underlayment for a roofing assembly for covering a roof deck and for facilitating the positioning of subsequent underlayments, the underlayments produced from a water-impermeable sheet imprinted on its top surface with one or more non-cylindrical designs in the shape of a closed figure or a polygon forming vertical and horizontal rows, and are inset from the marginal areas to allow positioning of the underlayments in abutting relationship to each other and to provide a visual means to an installer where the non-skid areas are ion the underlayment; an adhesive is coated on the underside of the underlayment for adhering the underlayment to the roof deck.

### BACKGROUND OF THE INVENTION

1. Field of the Invention

The present invention relates to a roofing underlayment for use as a substrate over a roof decking installed prior to the installation of roof shingles. More particularly, the present invention relates to non-skid underlayments.

2. Reported Developments

A persistent problem associated with roofing assemblies is wind uplift resulting in separation of a base sheet from a substrate such as the roof deck or a deck surfaced with an insulation layer. In areas of relatively higher wind velocity, it has been difficult to achieve the wind uplift resistance required by codes or building designers without using cost prohibitive construction techniques. In the case of nailable decks, it is often necessary to fasten the roof deck to the surfacing layers at short intervals thus increasing the time and expense of installation. On the other hand, several non-nailable decks have not been able to provide adequate resistance to wind uplift. Accordingly, several alternative methods, purported to avoid attachment failure have been suggested. Foremost is the use in the assembly of a uniformly perforated base sheet having circular perforations which permit flow of an adhesive through the apertures so as to adhere the sheet to the substrate. The adhesive can be applied by hot mopping over the perforated base sheet surface thus permitting flow-through and attachment of the sheet to the deck or an underlying insulation layer in the perforated area.

While this method is cost and time saving in that it eliminates the need for securing devices at critical intervals, it has not been found effective in environments subject to relatively higher wind velocities since the base sheets currently available do not provide sufficient adhesive force and sheet integrity to resist strong wind uplift forces. In the case of a conventionally perforated base sheet, merely widening the circular perforations or increasing their number is not a viable solution since either approach decreases the strength of the sheet.

The prior art has also addressed the installation problem of underlayment. It has been a rather important concern to provide an underlayment which allows the installer to safely walk on the roof when installing it without skidding and without injuries.

Accordingly, it is an object of this invention to provide a roof deck assembly which has superior resistance to wind uplift forces and other damage caused by weathering.

Still another object of this invention is to provide a new and improved base sheet or underlayment for roofing systems having high wind uplift resistance which is economical to produce and install.

It is still another object of the present invention to provide a skid-resistant roofing underlayment so that the installer could walk safely on the roof.

### SUMMARY OF THE INVENTION

The present invention provides a protective barrier or roofing underlayment for use as substrates over roof decking prior to installation of roofing materials including asphalt shingles, cement and terra cotta riles, metal roofing and other roof covering materials.

The underlayment sheet exhibits an upper surface and a lower surface. The upper surface incorporates a repeating non-intersecting pattern of shapes such that the edges form a line. These lines can be used to aid in location and proper application position of roofing on top of the underlayment. This pattern also provides an even placement of anti-slip material.

The underlayment sheet preferably is polyolefin, such as polyethylene or polypropylene.

Examplary disclosures of the above-mentioned issues/solutions include: U.S. Pat. Nos. 5,848,510, 6,134,856, 5,890,336, 6,308,482, 6,583,202, 6,378,259 and 5,687,517, and U.S. Publication Nos., 2005/0171223, 2005/097857, 2005/0227086.

U.S. Pat. Nos. 5,848,510, 5,890,336 and 6,378,259 disclose base sheets.

U.S. Pat. No. 6,134,856 discloses a pair of opposing selvage ends having embossed ridges and valleys. The membrane has an adhesive thereon.

U.S. Pat. No. 6,308,482 discloses a slip-resistant outer surface on the underlayment. The slip-resistant surface is formed of a sheet of woven polypropylene.

U.S. Pat. No. 5,687,517 discloses a skid-resistant roofing underlayment wherein the carrier sheet is corrugated with ridges.

U.S. Pat. No. 6,583,202 teaches a non-woven mat coated with an asphaltic composition.

U.S. Publication No. 2005/0097857 discloses a breathable, non-asphaltic roofing underlayment in which a thermoplastic film imparts skid-resistance.

U.S. Publication No. 2005/0227086 discloses a water vapor permeable, water-impermeable barrier sheet. A non-slip layer of ethylenemethylacrylate may be added to the exterior side of the polypropylene layer.

U.S. Pat. No. 6,378,259 discloses an underlayment with adhesive on the front and rear faces.

The non-slip material incorporated in the present invention is polyethylene, polypropylene, or a thermoplastic film.

The shapes and their relative position allow for foot contact with anti-slip materials on each step of the installer.

The thermoplastic film is typically ethylene methacrylate copolymer (EMA), ethylene acrylic based thermoplastic film, a polyester film, or ethyl-vinyl acetate (EVA).

The various shapes on the upper surface of the underlayment are produced by printing methods, such as by Gravure printing, which is well-known in the art.

### BRIEF DESCRIPTION OF THE DRAWINGS

FIG. I is a perspective view of the underlayment uniformly imprinted at sites 3 indicated by X. The thickness 13 of the underlayment can vary of from about 1-10 mm, the thickness of about 3 to 7 mm is preferred. The width of the underlayment is generally about 12, 24, 26, 40 (e.g. 1 meter) or 48 inches, and is typically supplied in rolls. The underlayment 10 includes on each of the four sides an overlap area defined by the numeral 2 and the numerals 4, 5, 6 and 7. The imprint X is positioned within the lines 4, 5, 6 and 7. The distance between X and the margins of the underlayment is of from about 10 inches to 16 inches or more. The distances are illustrated by the numerals 8, 9 and 11. The distance between the imprints is about 10 to 16 inches or more. The thermoplastic coating on the underside of the underlayment is indicted by the numeral 14.

FIG. II illustrates in schematic view the various configurations of the imprint from a to q. Configuration a is the most preferred configuration having a rectangular shape.

### DETAILED DESCRIPTION OF THE INVENTION

The underlayment 10 is typically supplied in rolls, has a width of about 12, 24, 26, 40 (e.g. 1 meter) and 48 inches. The thickness of the underlayment can vary from about 1 to 5 mm and a thickness of about 1.5 to about 3 mm is preferred.

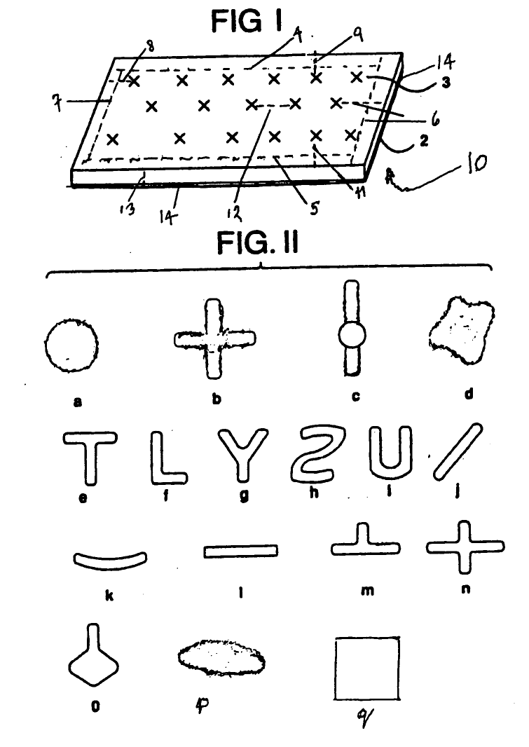

The underlayment 10 is shown in perspective view in FIG. 1 in which:
the imprints are denoted by X at site 3;
the width is generally about 12, 24, 36 and 48 inches defined by sides 2;
the overlap is defined by sides 2 and staggered lines 4, 5, 6 and 7;
the imprint X is positioned within the areas defined by lines 4, 5, 6 and 7 and sides 2; and
the thermoplastic coating on the underside of underlayment is denoted by the numeral 14.

The underlayment is imprinted with various shapes as illustrated in FIG. II. The shapes broadly termed as circular, ovate, lyrate, channel or slot, T-shape, I-shape, L-shape, Y-shape, star and bladder shape, square, and rectangular, among with the square shape is preferred. Each of these shapes individually or in combination with other shapes may be used to imprint the top surface of the underlayment.

The underlayment 10 is preferably made of non-skid polyethylene or polypropylene and is imprinted with one or more configurations of shapes shown in FIG. II. The distance between these configurations and the marginal areas of the underlayment is of about 10 to 16 inches or more allowing the foot of the installer to fit between the various configurations when the underlayment is of materials other than polyethylene or polypropylene.

Other materials which may be used to construct the device of the present invention includes, but are not limited to: SBS (styrene-butadiene-styrene), APP (atactic polypropylene), thermoset materials, such as EPDM, METALLOCENE®, cross-linked polyolefin, styrene-butadiene-rubber based and acrylic based elastomers, LDPE, VLDPV, ethylene vinyl acetate, thermoplastic materials such as PVC, and flexible polyurethanes.

To attach the underlayment to the deck of the roof, the underside of the underlayment is coated with an adhesive or a mixture of adhesives which include: self-adhesive acrylics, adhesives based on polyurethane, hot-melt thermoplastic adhesive which is applied at a temperature of about 180° C. to 250° C. with pressure, ethylene butyl acrylate (EBA) copolymers based for deep freeze hot-melt adhesive (HMA), hot-melt thermoplastic adhesives based on ethylene copolymers, propylene copolymers, polyvinylesters, polyamides, EPDM, polyvinyl acetates, acrylic resins and mixtures thereof, and pressure sensitive contact rubbers.

When the underlayment of the present invention is constructed from materials other than polyethylene or polypropylene which are inherently skid-resistant, the top surface of the underlayment may be coated with a layer of ethylenemethylacrylate.

In the roofing assembly utilizing an underlayment having large areas imprinted with various designs, the assembly comprises a roof deck, an insulation layer optionally positioned over the roof deck, and a non-skid or low-skid top surface area providing a safe surface on which the installer can walk during the installation process of the roof covering. For the purposes of this invention, the following terms are defined.

The substrate is the layer, sheet or deck immediately below the underlayment.

The underlayment is the base sheet coated with an adhesive on the underside thereof to permit attachment to the substrate.

The insulation as a rigid or semi-rigid material between the substrate and the underlayment which retards heat flow.

The underlayment is a waterproof layer associated with the use of roofing felt, asphalt and adhesives. The roofing assembly includes the underlayment and all layers or sheets above and below the underlayment.

The size of the imprints is of about 10 to 16 inches or more just like the distance between them so that the installer can fit his shoes between them or the rows or imprints. In general, the number of imprints depends on the width of the underlayment and the shape of the imprints. However, 2-4 imprints adjacent to the periphery of the underlayment should be present so that the installer may easily position subsequent rolls during the installation process.

The configurations shown in FIG. II are uniformly spaced on the underlayment and are usually inset form the marginal edges by at least 10 inches. In general, the inset by a margin should be sufficient to provide good manufacturability and effective attachability in the construction of the roofing assembly.

The imprinted underlayment of the present invention can be laid over a conventional roof deck such as one composed of gypsum, cement, wood or metal such as steel in a vented or non-vented system. When desired, a rigid or semi-rigid thermal insulation board of to 24 inch thickness containing PERLITE®, polyisocyanurate, polystyrene, polyurethane, fiber board, foam glass and combinations thereof, can be employed between the deck and the underlayment. Insulation can be omitted by option.

To prevent sticking between layers when shipped in rolls, the underlayment is usually contacted with a release agent such as sand, talc, or soap, or coated with a release sheet which is to be removed prior to the installation of the underlayment.

Based on the above specification, the present invention encompasses several embodiments thereof:

1. In one embodiment of the invention the underlayment comprises a flexible, water-impermeable sheet of polyethylene or polypropylene imprinted with a configuration of the designs shown in FIG. II. In this embodiment the non-skid requirement is provided by the inherent properties of the polyethylene or polypropylene.

To attach the underlayment to the roof deck, the underside of the underlayment is coated with an adhesive or a mixture of adhesives which include: self-adhesive acrylics, adhesives based on polyurethane, hot-melt thermoplastic adhesive which is applied at a temperature of about 180° C. to 250° C. with pressure, ethylene butyl acrylate (EBA) copolymers based for deep freeze hot-melt adhesive (HMA), hot-melt thermoplastic adhesives based on ethylene copolymers, propylene copolymers, polyvinylesters, polyamides, EPDM, polyvinyl acetates, acrylic resins and mixtures thereof, and pressure sensitive contact rubbers.

The underlayment is supplied in roll form and a release agent or film is used to cover the adhesive to facilitate shipment of the underlayment prior to its installation.

2. In another embodiment of the present invention the underlayment comprises: SBS (styrene-butadiene-styrene), APP (atactic polypropylene), thermoset materials, such as EPDM, METALLOCENE®, cross-linked polyolefin, styrene-butadiene-rubber based and acrylic based elastomers, LDPE, VLDPV, ethylene vinyl acetate, thermoplastic materials such as PVC, and flexible polyurethanes.

The top surface of the underlayment in this embodiment is completely coated with a layer of ethylenemethyleacrylate to render the top surface skid-resistant.

The bottom surface of the underlayment in this embodiment is coated with an adhesive or a mixture of adhesives described above.

3. In yet another embodiment of the present invention, the underlayment comprises: SBS (styrene-butadiene-styrene), APP (atactic polypropylene), thermoset materials, such as EPDM, METALLOCENE®, cross-linked polyolefin, styrene-butadiene-rubber based and acrylic based elastomers, LDPE, VLDPV, ethylene vinyl acetate, thermoplastic materials such as PVC, and flexible polyurethanes.

In this embodiment the top surface of the underlayment is coated only where the configuration of the imprint appears in horizontal and vertical arrangements. The coating layer is ethylenemethylacrylate.

The underlayment on its underside is coated with an adhesive or a mixture of adhesives described in embodiment 1.

The release agent or film is used to cover the adhesive to facilitate shipment of the underlayment prior to its installation. Preferably, an instructional is embedded to warn the installer as to where to step on portions of the underlayment to avoid skidding.

4. In still another embodiment of the present invention, the underlayment comprises: SBS (styrene-butadienestyrene), APP (atactic polypropylene), thermoset materials, such as EPDM, METALLOCENE®, cross-linked polyolefin, styrene-butadiene-rubber based and acrylic based elastomers, LDPE, VLDPV, ethylene vinyl acetate, thermoplastic materials such as PVC, and flexible polyurethanes.

In this embodiment the top surface of the underlayment is coated only between the configuration of the imprint which appears in horizontal and vertical arrangements. The coating layer is ethylenedimethylacrylate.

The underlayment on its underside is coated with an adhesive or a mixture of adhesives described in embodiment 1.

The release agent or film is used to cover the adhesive to facilitate shipment of the underlayment prior to its installation. Preferably, an instructional is embedded to warn the installer as to where to step on portions of the underlayment to avoid skidding.

The underlayment of the present invention can be laid on the roof deck as panels abutted in side-by-side or overlapping relationship. The final roofing assembly includes layers above the underlayment which are conventionally employed in a roof assembly. These additional layers include saturated felt, polymer modified roofing materials, optionally an insulation membrane and other layers desired in the assembly. Generally, the roofing assembly is capped with a weather-resistant surface layer.

It is to be understood that various modifications can be made based on the disclosure of the present invention without departing from the spirit of the invention. It is therefore intended that the invention not be limited to the exact form described and illustrated, but should be constructed to cover all modification that may fall within the scope of the appended claims.

1. A vertically collapsible vertical axis wind turbine comprising: a substantially vertical shaft; at least two vane supports mounted by the shaft; and at least two vertically collapsible material vanes supported by the vane supports, so that the vanes are movable from a first operative position in which the vane material is substantially taut, to a second inoperative position in which the vane material collapses and is not taut; and wherein the vane supports are positioned, and the vanes are constructed, so that the wind turbine has a Savonius configuration.

2. A vertically collapsible vertical axis wind turbine as recited in claim 25 wherein the vane supports are positioned, and the vanes are constructed, so that the wind turbine has an open helix configuration.

3. (canceled)

4. A vertically collapsible vertical axis wind turbine as recited in claim 1 wherein at least one of the vane supports comprises a first vane support mounted to the shaft by a locking device, the locking device removable to allow movement of the first vane support with respect to other vane supports along the shaft.

5. A vertically collapsible vertical axis wind turbine as recited in claim 25 wherein the first vane support comprises the top vane support.

6. A vertically collapsible vertical axis wind turbine as recited in claim 25 wherein the locking device comprises a locking pin extendable through aligned substantially horizontal openings in the shaft and first vane support.

7. A vertically collapsible vertical axis wind turbine comprising: a substantially vertical shaft; at least two vane supports mounted by the shaft; and at least two vertically collapsible material vanes supported by the vane supports, so that the vanes are movable from a first operative position in which the vane material is substantially taut, to a second inoperative position in which the vane material collapses; and wherein each vane support comprises a hub having a central substantially vertical bore, and a plurality of curved spokes extending generally radially outwardly from the hub and operatively connected to a vane.

8. A vertically collapsible vertical axis wind turbine as recited in claim 7 wherein the hub central bore and the shaft have at least one radially extending projection and vertically elongated groove which cooperate to key the vane support to the shaft.

9. A vertically collapsible vertical axis wind turbine as recited in claim 8 wherein the at least one radial projection is in the hub central bore and the at least one vertically elongated groove is in the shaft.

10. A vertically collapsible vertical axis wind turbine as recited in claim 1 wherein the vanes are made of kite or high performance sail material, and wherein at least one vane includes at least one substantially vertical or substantially diagonal removable batten therein.

11. A vertically collapsible vertical axis wind turbine as recited in claim 7 wherein each vane support has at least three spokes spaced substantially uniformly around the hub.

12. A vertically collapsible vertical axis wind turbine as recited in claim 7 wherein the spokes of the lowest vane support on the shaft have a smaller radial dimension than the spokes of a vane support above them, so that the vane is tapered radially inwardly from the above vane support to the lowest vane support.

13. A vertically collapsible vertical axis wind turbine as recited in claim 4 comprising at least three vane supports vertically spaced from each other on the shaft, and a second vane support mounted to the shaft by a removable locking device.

14. A multihull watercraft comprising: a plurality of hulls; a propulsion mechanism operatively mounted between two of the hulls; a vertically collapsible Savonius or open helix vertical axis wind turbine operatively mounted to at least one hull, the wind turbine having a shaft; and an operative mechanical connection between the wind turbine shaft and the propulsion mechanism.

15. (canceled)

16. A multihull watercraft as recited in claim 14 further comprising at least two vane supports mounted by the shaft and at least two vertically collapsible material vanes supported by the vane supports, so that the vanes are movable from a first operative position in which the vane material is substantially taut, to a second inoperative position in which the vane material collapses and is not taut.

17. A multihull watercraft as recited in claim 14 wherein the propulsion mechanism comprises a substantially horizontal propeller and wherein the operative connection between the wind turbine shaft and propeller comprises a flexible shaft having at least about a 70 degree bend therein.

18. (canceled)

19. A watercraft comprising: a watercraft body; a vertical axis wind turbine having a substantially vertical shaft mounted with respect to the body for rotation with respect to the body; a substantially horizontal propeller mounted to the body for rotation about a generally horizontal axis; and a flexible shaft having at least about a 70 degree bend therein operatively connecting the wind turbine shaft to the substantially horizontal propeller and a manually actuated clutch between the wind turbine shaft and the flexible shaft, the clutch positioned above the flexible shaft bend.

20. (canceled)

21. A multihull watercraft comprising: a plurality of hulls, having at least portions thereof which normally engage water made of low friction marine grade polyethylene; a substantially horizontal propeller having a diameter of at least about ten inches and operatively mounted between two of said hulls; a vertical axis wind turbine operatively mounted to at least one hull, said wind turbine having a shaft; and an operative mechanical connection between said wind turbine shaft and said propeller.

22. A vertically collapsible vertical axis wind turbine as recited in claim 7 wherein at least one of the vane supports comprises a first vane support mounted to the shaft by a locking device, the locking device removable to allow movement of the first vane support with respect to other vane supports along the shaft.

23. A vertically collapsible vertical axis wind turbine as recited in claim 7 comprising at least three vane supports vertically spaced from each other on the shaft, including at least first and second vane supports mounted to the shaft by a removable locking element.

24. A vertically collapsible vertical axis wind turbine as recited in claim 7 operatively mounted to at least one hull of a multihull watercraft, and in combination with a propulsion mechanism operatively mechanically connected to said turbine shaft.

25. A vertically collapsible vertical axis wind turbine comprising: a substantially vertical shaft; at least two vane supports mounted by the shaft; and at least two vertically collapsible material vanes supported by the vane supports, so that the vanes are movable from a first operative position in which the vane material is substantially taut, to a second inoperative position in which the vane material collapses and is not taut; and wherein at least one of the vane supports comprises a first vane support mounted to the shaft by a locking device, the locking device removable to allow movement of the first vane support with respect to other vane supports along the shaft.
